(19) United States
(12) Patent Application Publication
(10) Pub. No.: US 2014/0263906 A1
(43) Pub. Date: Sep. 18, 2014

(54) COLLAPSIBLE SPORTS BOARD SUPPORT ASSEMBLY

(71) Applicant: Raymond L. Jesewitz, Longwood, FL (US)

(72) Inventor: Raymond L. Jesewitz, Longwood, FL (US)

(21) Appl. No.: 14/218,947

(22) Filed: Mar. 18, 2014

Related U.S. Application Data
(60) Provisional application No. 61/802,516, filed on Mar. 16, 2013.

(51) Int. Cl. F16M 13/02

(52) U.S. Cl. CPC F16M 13/02
USPC 248/288.11; 248/316.8

(57) ABSTRACT

A collapsible sports board support assembly for removable attachment to a support structure, which can be mounted onto boats and other support structures, for supporting wake boards, snow boards, surf boards and various other sports boards. The apparatus includes at least one foldable board support fork hingedly attached to the support structure, the fork having prongs extending away from the support structure, where the foldable support fork is folded onto the support structure to minimize the space occupied by the assembly and to minimize the hazards associated with protruding forks. One embodiment includes a rotatable and pivotable support base which, in combination with the ability to fold the board support forks, allows the sports board support assembly to be nearly infinitely repositionable and adjustable and therefore is uniquely compatible with adjustable support structures such as height adjustable towers which change angles as the tower is raised or lowered.

### BACKGROUND OF THE INVENTION

The invention provides collapsible assembly for supporting wake boards, snow boards, surf boards and various other sports boards.

### SUMMARY OF THE INVENTION

The present invention is a distinctive collapsible sports board support assembly which can be mounted onto boats and other support structures. The collapsible sports board support assembly includes folding forks which can be collapsed or folded to minimize the hazards associated with protruding forks and to minimize the space taken up by the assembly.

### BRIEF DESCRIPTION OF THE DRAWINGS

FIG. 1 shows a collapsible sports board support assembly for wakeboards.

FIG. 2 shows a collapsible sports board support assembly for snowboards.

FIG. 3 shows a collapsible sports board support assembly mounted on a boat.

FIG. 4 shows a collapsible sports board support assembly mounted on a boat.

FIG. 5 shows a collapsible sports board support assembly mounted on a boat.

FIG. 6 shows a sports board being mounted to a collapsible sports board support assembly.

FIG. 7 shows a sports board being mounted to a collapsible sports board support assembly.

FIG. 8 shows a sports board being mounted to a collapsible sports board support assembly.

FIG. 9 shows collapsible sports board support assembly with one folded fork.

FIG. 10 shows a collapsible sports board support assembly as combined with a sports board.

FIG. 11 shows a collapsible sports board support assembly as combined with a sports board with the forks partially folded to accommodate boot and binding.

FIG. 12 shows a collapsible sports board support assembly with a board securing cord.

FIG. 13 shows a collapsible sports board support assembly with a board securing cord.

FIG. 14 shows the fork attachment hinge and fork hinge quick release handle.

FIG. 15 shows a board support mount.

FIG. 16 shows a board support mount.

FIG. 17 shows a board support mount.

FIG. 18 shows a quick release handle and a quick release bolt.

FIG. 19 shows a collapsible sports board support assembly being mounted to a boat support structure.

FIG. 20 shows a supplemental base support mount holder.

FIG. 21 shows the board support base mount rotational section and its companion slot.

FIG. 22 shows a collapsible sports board support assembly mounted to a boat structure with the forks folded (stowed position).

FIG. 23 shows the board support base mount rotational section and its aperture.

FIG. 24 shows a collapsible sports board support assembly mounted to a boat structure with the forks folded and positioned horizontal to the boat deck.

FIG. 25 shows a collapsible sports board support assembly mounted to a boat structure with the forks folded and positioned horizontal to the boat deck.

FIG. 26 shows a collapsible sports board support assembly mounted to a boat structure with the forks folded and positioned at a rotated angle from the boat deck.

FIG. 27 shows a collapsible sports board support assembly mounted to a boat structure with the forks unfolded (board mounting position).

FIG. 28 shows a collapsible sports board support assembly mounted to a boat structure with the forks unfolded (board mounting position).

FIG. 29 shows a support structure mounted to a boat gunwale with an integrated support base.

FIG. 30a shows board forks and hinges in the unfolded position (board mounting position) for mounting to a support base integrated into a support structure.

FIG. 30b shows board forks and hinges with one fork in the folded position and the other fork in the unfolded position.

FIG. 30c shows board forks and hinges in the folded position (stowed position) for mounting to a support base integrated into a support structure.

FIG. 31 shows board forks and hinges in the unfolded position (board mounting position) mounted to an integrated support base as part of a support structure.

### DETAILED DESCRIPTION OF THE PREFERRED EMBODIMENT

The present invention is a collapsible sports board support assembly as shown in FIG. 1-FIG. 31.

The preferred embodiment of the invention, as shown at least in FIGS. 1-10 is a collapsible sports board support assembly 100 which includes a pair of board support forks 110 hingedly interconnected by a board support base 120. The board support assembly includes a board support mount 130 which is attached to the board support base 120 for removably and pivotally mounting the collapsible sports board support assembly 100 to various structures such as boat towers, vehicles, and static supports.

In the preferred embodiment of the invention each of the board support forks 110 include at least two, most preferably three, fork prongs 115 which extend outward from the board support base 120.

Alternate board support forks 110 may include four or more board support fork prongs 115 as needed.

The board support fork prongs 115 extend to a distance suitable for securing the applicable sports board 101 between a pair of the fork prongs 115 as shown in FIG. 10.

Typically the length of the fork prongs 115 is approximately one-half the width of the sports board 101 which is to be supported. This allows safe and secure support of the sports board 101 while minimize the length of the fork prongs 115.

Its is further envisioned that the length of the fork prongs 115 can be optimized for the type and width of sports board 101 to be supported by determining the width and weight of the sports board 101 and selecting fork prongs 115 suitable for securely holding the anticipated load.

Further, as shown in FIGS. 5-7, the fork prongs 115 may be positioned at an angle to the board support base 120 thereby by shifting the center of gravity of the supported supports board 101. With the shift in the center of gravity of the supported sports board 101, the length of the fork prongs 115 are complimentarily modified to provide the appropriate support. For example if the fork prongs 115 are angled at less than 45 degrees from the board support base 120 (clockwise rotation applied) the sports board 101 center of gravity will be directed towards the board support base 120 and short the fork prongs 115 may adequately support the sports board 101.

As the fork prongs 115 are angled further away from the board support base 120 (clockwise rotation applied) the sports board 101 center of gravity will be directed further away from the board support base 120 and longer fork prongs 115 may be required to adequately support the sports board 101.

As shown in at least, FIGS. 30b and 30c, it is novel to be able to fold two board forks that are approximately 11″ in length into a space in between the board forks that is only 8.5″ in width. It requires the board fork angle to be optimized in order to utilize the space between the board forks which is limited by the distance between the bindings on a wakeboard. As the angle of the forks increases, less width between the forks is required to fold them. The angle of the forks is often a critical factor in minimizing the required width between the board forks. This space optimizing factor creates a unique functionality of the device.

Further the distance between each pair of fork prongs 115 is selected to be suitable with the anticipated thickness of the applicable sports board 101.

It is anticipated that additional structural features or elements may be provided to assist the fork prongs 115 in retaining the inserted sports board 101.

As previously stated the fork prongs 115 are hingedly attached 116 to the board support base 120 which allows the fork prongs 115 to be folded inward towards the board support base 120. The length of the fork prongs 115 will effect the ability of the forks to be folded therefore an optimized selection of the length of the fork prongs 115 with relation to the sports board 101 width is preferable.

As shown in FIG. 14, the attachment hinge 116 preferably includes a fork hinge quick release handle 117 to lock or release the pivotal movement of the fork prongs 115. The fork prongs 115 and board support base 120 are hingedly attached together similar to the hinged attachment of a door to a door frame.

An added advantage of the foldable fork prongs 115 is that, as shown in FIG. 10 and FIG. 11, the fork prongs 115 can be pivoted to support a variety of sports board widths. This is also important because sports boarders such as ski boarders users mount boots and bindings 111 to the surface of the sports board 101 at a width approximately equal to the width of the users shoulders and the mounted boots and binders 111 can interfere with placing the sports board 101 into a board support assembly 100.

By pivoting or folding the foldable fork prongs 115 slightly to accommodate the placement of the boots and bindings 111, users can retain their preferred boot mount position. In contrast, with sports board support assemblies having rigidly attached fork prongs the users will have to remove their boots from the sports board prior to mounting the sports board onto the sports board support assembly and then re-install the boots onto the sports board assembly when the users want to use the sports board 101.

With the sports board 101 placed into the sports board support assembly 100, a board securing cord 118, such as a bungee cord, can be used to further secure the sports board to the sports board support assembly 100.

The entire collapsible sports board support assembly 100 is removably and pivotally mounted onto a support structure 102 such as boat towers, vehicles, and static supports via board support base 120 and base support mount 130.

The board support base mount 130 includes a rotational section 134 which locks into position via a support base mount quick release handle 135, and support base mount quick release bolt 136 as shown at least in FIGS. 15-18 and FIGS. 25-26. Locking the support base mount quick release handle 135 prevents the rotation of the rotational section 134 and thereby prevents the sports board support assembly 100 from rotation in a clockwise or counter-clockwise direction. Releasing the lock allows free rotation of the board support base 120.

As shown in at least in FIG. 21 and FIG. 23, the board support base mount rotational section 134 includes an aperture 137 and a companion slot 138 thru which the support base mount quick release bolt 136 (see FIG. 18) and extends when inserted to prevent or allow rotation of the board support base 120.

The base support mount 130 may be attached directly to the support structure 102 or, as shown in FIGS. 20 and 24, the base support mount 130 may be positioned on a supplemental base support mount holder 139, which is attached to the applicable support structure 102. The base support holder mount 139 may be and independent mounting element or a section of the support structure 102 (such as a boat tower) which includes mounting deformations (not shown) designed to allow the board support base 120 to be positioned substantially flush with the support structure 102.

Whether the base support mount 130 is attached directly to the support structure 102 or to a supplemental base support mount holder 139, a removable base support mount securing pin 130a is used to further secure the base support mount 130 to the applicable structure. The purpose of the support mount securing pin 130a is to affect (prevent or allow) rotation of the base support mount on the supporting structure 102 or on the supplemental base support mount holder 139. The removable base support mount securing pin 130a may be provided as a quick release mechanism having a quick release handle or as a completely removable pin.

The combination of the ability to rotate the board support base 120 and the base support mount 130, as well as the ability to fold the fork prongs 115 allows the sports board support assembly 100 to be nearly infinitely repositionable and adjustable and therefore the collapsible sports board support assembly 100 of the instant invention is uniquely compatible with adjustable support structures 102 such as height adjustable towers which change angles as the tower is raised or lowered as taught in U.S. Pat. No. 8,297,484.

As an alternative embodiment as shown in at least in FIGS. 29 through 31, the board forks 210 and hinges 216 may be mounted directly to an integrated support base 103 as a part of a support structure 102 as a cost reduction method.

Note the gunwale 140 is considered a part of the boat deck. As shown in FIG. 29 the support structure 102 may comprise multiple support structures 102 attached to the boat deck along the same port or starboard gunwale 140.

An additional alternative embodiment (not shown) incorporates a drive mechanism to actuate the folding and unfolding of the board forks 110. Various methods such as cable gears, actuated struts, or motor-driven gears may be used to move the board forks for ease of use to the user.

Further, the support structures discussed herein are not considered an exhaustive list of support structures and it is anticipated the instant invention is useable with a variety of support structures 102 such as support assemblies on vehicles as well as support assemblies for mounting sports equipment to walls or other non-mobile structures.

It is understood the components of the instant invention are constructed from materials suitable to the applicable usage environment.

While various embodiments of the present invention may be shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A collapsible sports board support assembly for removable attachment to a support structure comprising:
at least one foldable board support fork hingedly attached to the support structure, the fork having prongs extending away from the support structure,
wherein the at least one foldable support fork is folded onto the support structure to minimize the space occupied by the assembly.

2. A collapsible sports board support assembly for removable attachment to a support structure comprising:
at least one foldable board support fork hingedly attached to the support base, the fork having prongs extending away from the support base,
wherein the at least one foldable support fork is folded onto the support base to minimize the space occupied by the assembly.

3. The collapsible sports board support assembly of claim 2 wherein the support base is rotatable.

4. The collapsible sports board support assembly of claim 2 wherein the support base is pivotable.

5. A collapsible sports board support assembly for removable attachment to a support structure comprising:
a rotatable and pivotable support base;
at least one foldable board support fork hingedly attached to the support base, the fork having prongs extending away from the support base,
wherein the at least one foldable support fork is folded onto the support base to minimize the space occupied by the assembly.
